(19) United States
(12) Patent Application Publication
(10) Pub. No.: US 2014/0197707 A1
(43) Pub. Date: Jul. 17, 2014

(54) MAGNETIC DRIVE APPARATUS

(71) Applicant: Andrew Boyd FRENCH, Via Karuah NSW (AU)

(72) Inventor: Andrew Boyd FRENCH, Via Karuah NSW (AU)

(21) Appl. No.: 13/942,066

(22) Filed: Jul. 15, 2013

Related U.S. Application Data
(63) Continuation of application No. 13/451,116, filed on Apr. 19, 2012, now abandoned.
Application No. 13/451,116 is a continuation of application No. 11/911,005, filed on Jan. 16, 2008, now abandoned.

(30) Foreign Application Priority Data
Apr. 8, 2005 (AU) 2005901762

(51) Int. Cl. H02K 49/10

(52) U.S. Cl. CPC H02K 49/102
USPC 310/103

(57) ABSTRACT

A primary disc and the secondary discs are each fitted with magnetic means, typically in the form of permanent magnets of the same polarity, located along a radial line from the centre point of the discs, and arranged generally transverse to the axis of rotation of the respective disc. These magnets are also located at or adjacent to the periphery of the disc(s). The magnets are embedded into each of the primary and secondary discs such that the faces of the magnets are flush with the exterior faces of the primary and secondary discs. In some embodiments, the magnets on the primary and secondary discs are arranged so as to be parallel, with their respective elongate, straight side edges aligned. Such an arrangement can result in less slippage between the discs which hold the magnets, and can assist in handling some misalignment which may occur between these discs during use, thus allowing smoother operation.

### TECHNICAL FIELD

The present invention relates generally to a magnetic drive apparatus and more particularly though not exclusively, to drives and bearings employing magnetically coupled transmissions.

### BACKGROUND

Known methods of transferring drive from engines and motors to gearboxes, pumps, alternators, generators and compressors is accomplished by various forms of physical couplings, including pulley belts, chains, gears, discs, cogs and other couplings. There are many problems associated with mechanical couplings such as the requirement for periodic lubrication of gears, close alignment requirements of the various components, and issue of wear and tear. Energy losses in the form of friction and heat loss can be considerable in such apparatus.

### SUMMARY OF THE INVENTION

In a first aspect the present invention provides a magnetic drive apparatus comprising:

a primary and two secondary supports, each support being rotatable around an axis of rotation; and

a plurality of magnets arranged around and at or adjacent to a periphery of each support;

wherein the secondary supports are spaced and generally parallel, and the primary support is arranged in use to move in the space between the secondary supports such that, at a given time, at least some of the primary magnets are located between at least some of the secondary magnets of each of the secondary supports.

In an embodiment, the magnets of the primary and secondary supports can be each oriented so that the poles of said at least some primary magnets provide a repulsive magnetic force to said at least some secondary magnets.

In an embodiment, the primary support can be a disc that is mounted to rotate on the end of a primary shaft and the secondary supports are each discs mounted to rotate on a common secondary shaft. In one form of this, the primary shaft can be parallel in use to the secondary shaft.

In further forms, the secondary discs can each have the same diameter that is a smaller diameter than the primary disc.

In an embodiment, the magnets on at least one support can be energised by at least one electromagnet to induce rotation between the primary and secondary supports.

In an embodiment, each of the magnets can be shaped to improve torque generation. In one form, each magnet can have an ovaloid shape. In another form, each magnet can have an obround shape.

In an embodiment, each of the magnets is elongate and has an elongate axis that is inclined to a radius extending from a centre of each support. In one form, the elongate axis subtends an acute or right angle to the radius, or the magnets on each support have varying combinations of these orientations.

In still further embodiments, each of the magnets may have a shape that is selected from one or more of square, triangular, ovaloid, obround, rhomboid, or truncated cylinder.

In some embodiments, the magnets in each support can be mounted to project beyond the outer periphery thereof, or are mounted to recess into the outer periphery.

In a second aspect, the present invention provides a magnetic drive apparatus comprising:

primary and secondary supports, each support being rotatable around an axis of rotation that is parallel or inclined with respect to the other axis; and

a plurality of magnets arranged around each support;

wherein each support has a generally conical shape, with a major cone face of one support facing a major cone face of the other support in use.

In one embodiment, each magnet can be elongate and is arranged in major cone face to extend from an apex towards a base of the cone. In one form of this, each magnet can have the form of a frusto-conical segment.

In one embodiment, the magnets in one support may be oriented to provide a repulsive magnetic force to the magnets in the other support.

In one embodiment, the supports can each be mounted to rotate on the end a respective shaft. In one form, the axis of one shaft is in use orthogonal to the axis of the other shaft.

In one embodiment, each support can be frusto-conically shaped.

In a third aspect, the present provides a magnetic drive apparatus comprising:

a primary and a secondary support, each support being rotatable around an axis of rotation; and

a plurality of magnets arranged around and at or adjacent to a periphery of each support;

wherein the magnets are elongate and are generally arranged in alignment with the axis of rotation of the respective support.

In one embodiment, the primary and secondary supports can be spaced apart.

In one embodiment, the primary support can be a disc that is mounted to rotate on a primary shaft and the secondary support can also be a disc mounted to rotate on a secondary shaft.

In one embodiment, the primary shaft can be parallel in use to the secondary shaft.

In one form of this, the magnets on the primary support may be arranged parallel with the magnets on the secondary support in use.

In one embodiment, the secondary disc can have a diameter that is a smaller than the diameter of the primary disc.

In one embodiment, each magnet can have a rectangular shape when viewed in plan or in cross-section.

In one embodiment, the magnets in each support can be mounted to project beyond the outer periphery thereof, or can be mounted to recess into the outer periphery.

In a fourth aspect, the present invention provides a magnetic drive apparatus comprising:

a primary and a secondary support, each support being rotatable around an axis of rotation; and

a plurality of magnets arranged around and at or adjacent to a periphery of each support;

wherein the magnets are elongate and are generally arranged transverse to the axis of rotation of the respective support.

In one embodiment, each of the magnets can have an axis that is inclined to a radius extending from a centre of each support.

In an alternative embodiment, the elongate axis can subtend an acute or right angle to the radius, or the magnets on each support can have varying combinations of these orientations.

In a further alternative embodiment, each of the magnets can have an axis that is aligned with a radius extending from a centre of each support.

In one embodiment, the magnetic drive apparatus of the fourth aspect is otherwise as defined in the third aspect.

In a fifth aspect, the present invention provides a magnetic coupling apparatus comprising:

primary and secondary elongate shafts, each shaft having an elongate axis that is aligned with the other in use, and each being rotatable around its elongate axis;

one or more primary magnets arranged around a first end of the primary shaft; and

one or more secondary magnets arranged at an end of the secondary shaft that is located adjacent to the primary shaft first end in use, the secondary magnets being arranged such that the primary magnets are located in use to rotate within the secondary magnets.

In one embodiment, the primary and secondary magnets can each be oriented so that the poles of the primary magnets provide a repulsive magnetic force to the secondary magnets.

In one embodiment, a plurality of primary magnets can surround the primary shaft first end.

In one embodiment, the secondary magnets may be arranged within a housing that is mounted to the secondary shaft end to rotate therewith, with the primary shaft first end being located within the housing in use. In one form of this, the housing is a casing assembled form two halves and then mounted to the secondary shaft end to define the housing.

In one embodiment, the housing can have a bearing located at an entrance thereto through which the primary shaft extends to be supported for rotation therein in use.

In one embodiment, the primary and/or secondary magnets can be elongate.

### BRIEF DESCRIPTION OF THE DRAWINGS

It is convenient to herein describe an embodiment of the present invention with reference to the accompanying drawings. The particularity of the drawings and the related description is to be understood as not superseding the generality of the preceding broad description of the invention.

In the drawings:

FIG. 1 shows a side view of one embodiment of primary and secondary supports in the form of discs which comprise part of the magnetic drive apparatus in accordance with the invention;

FIG. 2 shows a top plan view of the embodiment shown in FIG. 1;

FIG. 3 shows a side view of a further embodiment of primary and secondary supports in the form of discs which comprise part of the magnetic drive apparatus in accordance with the invention;

FIG. 4 shows a side view of a further embodiment of primary and secondary supports in the form of discs which comprise part of the magnetic drive apparatus in accordance with the invention;

FIG. 5 shows a side view of a further embodiment of primary and secondary supports in the form of discs which comprise part of the magnetic drive apparatus in accordance with the invention;

FIG. 6 shows a side view of one embodiment of primary and secondary supports in the form of discs which comprise part of the magnetic drive apparatus in accordance with the invention;

FIG. 7 shows a top plan view of the embodiment shown in FIG. 6;

FIG. 8 shows a side view of one embodiment of primary and secondary supports in the form of discs which comprise part of the magnetic drive apparatus in accordance with the invention;

FIG. 9 shows a top plan view of the embodiment shown in FIG. 8;

FIG. 10 shows a side view of one embodiment of primary and secondary supports in the form of discs which comprise part of a magnetic drive apparatus;

FIG. 11 shows a top plan view of the embodiment shown in FIG. 10;

FIG. 12 shows an end view of the embodiment shown in FIGS. 10 and 11;

FIG. 13 shows a side view of one embodiment of primary and secondary supports in the form of discs which comprise part of a magnetic drive apparatus;

FIG. 14 shows a top plan view of the embodiment shown in FIG. 13;

FIG. 15 shows a side view of one embodiment of primary and secondary supports in a generally conical form which comprise part of a magnetic drive apparatus;

FIG. 16 shows a side view of the embodiment shown in FIG. 15;

FIG. 17 shows an end view of an embodiment of a magnetic coupling apparatus in accordance with the invention;

FIG. 18 shows a partially sectioned side view of the embodiment shown in FIG. 17;

FIG. 19 shows an end view of an embodiment of a magnetic coupling apparatus in accordance with the invention;

FIG. 20 shows a partially sectioned side view of the embodiment shown in FIG. 19.

### DETAILED DESCRIPTION OF EMBODIMENTS OF THE INVENTION

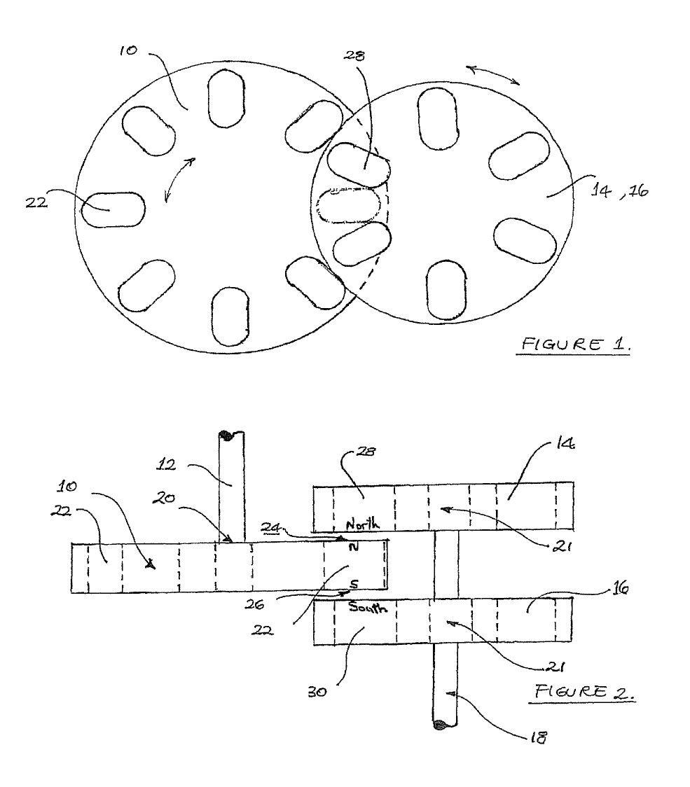

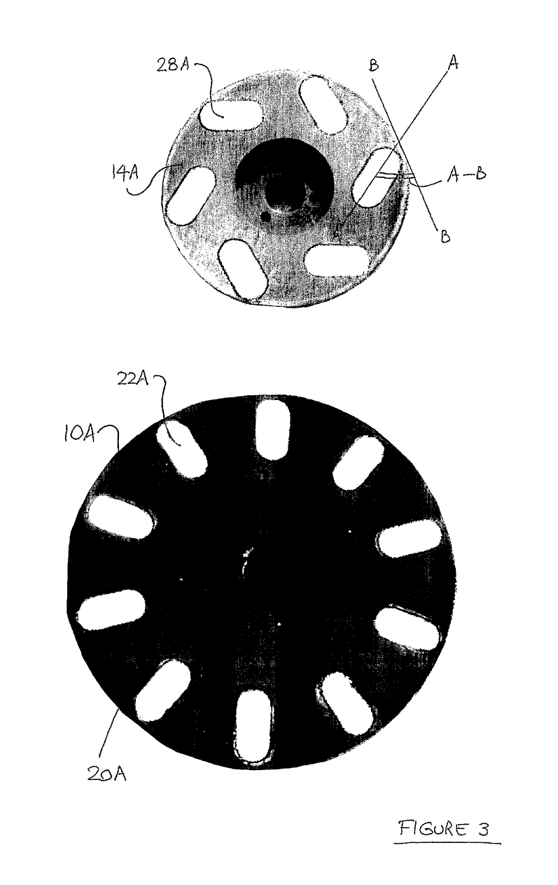

Referring to the drawings an embodiment of part of a magnetic drive apparatus is shown in FIGS. 1 and 2. A primary disc 10 that is circular in shape is positioned on a first shaft 12 and two spaced-apart secondary discs 14, 16 that are also circular in shape are positioned on a second shaft 18. The first 12 and second 18 shafts are aligned generally parallel. The first shaft 12 is positioned at the centrepoint 20 of the primary disc and orthogonal thereto. Similarly, the second shaft 18 is positioned orthogonally to each of the secondary discs 14, 16, and passes through the centrepoint 21 of each. In the embodiment shown, the primary 12 and secondary 18 shafts are both oriented in the same longitudinal plane but offset to each other. The primary 12 and secondary 18 shafts also extend in opposing directions. The spaced apart secondary discs 14, 16 are generally parallel and, in use, the primary disc 10 is arranged to move in the space between the secondary discs 14, 16 so that the discs 10, 14, 16 overlap to some extent.

The primary disc 10 and the secondary discs 14, 16 shown in the drawings are each fitted with magnetic means, typically in the form of permanent magnets of the same polarity, located along a radial line from the centrepoint of the discs, and arranged generally transverse to the axis of rotation of the respective disc support. As shown in the drawings, these magnets are also located at or adjacent to the periphery of the disc(s). The magnets are embedded into each of the primary 10 and secondary 14, 16 discs such that the faces of the magnets are flush with the exterior faces of the primary 10 and secondary 14, 16 discs. In the embodiment shown, the magnets 22 that are embedded in the primary disc 10 are each oriented such that the polarity of the outer face 24, 26 of each magnet (ie. the face located at the opposing surfaces of the primary disc 10) matches the polarity of the outer face of a magnet 28 positioned in each of the adjacent two secondary discs 14, 16. In the embodiment shown in FIG. 2, each of the magnets 22 embedded in the primary disc 10 has a North pole which is aligned with a North pole of a magnet 28 embedded in the secondary disc 14. Each of the South pole of those magnets 22 embedded in the primary disc 10 has a South pole which is aligned with a South pole of a magnet 30 embedded in the other secondary disc 16.

The primary disc 10 is positioned between two secondary discs 14, 16 so that the centre of the magnets 22, 28, 30 on each of the primary disc 10 and secondary discs 14, 16 can be in vertical (or horizontal) alignment. The primary 10 and secondary 14, 16 discs are oriented such that when the two secondary discs 14, 16 are rotated by the second shaft 18, the primary disc 10 is caused to rotate due to repulsive forces, thereby rotating the first shaft 12. Alternatively, when the primary disc 10 is rotated by a first shaft 12, the secondary discs 14, 16 are caused to rotate due to repulsive forces, thereby rotating the second shaft 18. The primary discs 10 and secondary discs 14, 16 can be independently connected to, and rotated by, any rotational energy source, such as a motor, a turbine, a windmill etc. In some embodiments, the offset between the first and second shaft may be adjusted to control the extent of magnetic interaction, so long as that, at a given time, at least some portion of the magnets 22 on the primary disc 10 are located between at least some of the magnets 28, 30 on the secondary disc(s) 14, 16.

Furthermore, in other embodiments, the first and second shafts can extend from the same direction, rather than from opposing directions, as is shown in FIG. 2. Whilst in the embodiment shown in FIGS. 1 and 2 the first 12 and second 18 shafts have the same diameter, in other embodiments the first and second shafts may be of different diameters relative to each other. Whilst in the embodiment shown in FIGS. 1 and 2 the primary 10 and secondary 14, 16 discs have a different diameter with the primary disc 10 being of greater diameter than each of the secondary discs 14, 16, in other embodiments the discs may be of the same diameter or indeed the secondary discs can be larger in diameter than the primary disc.

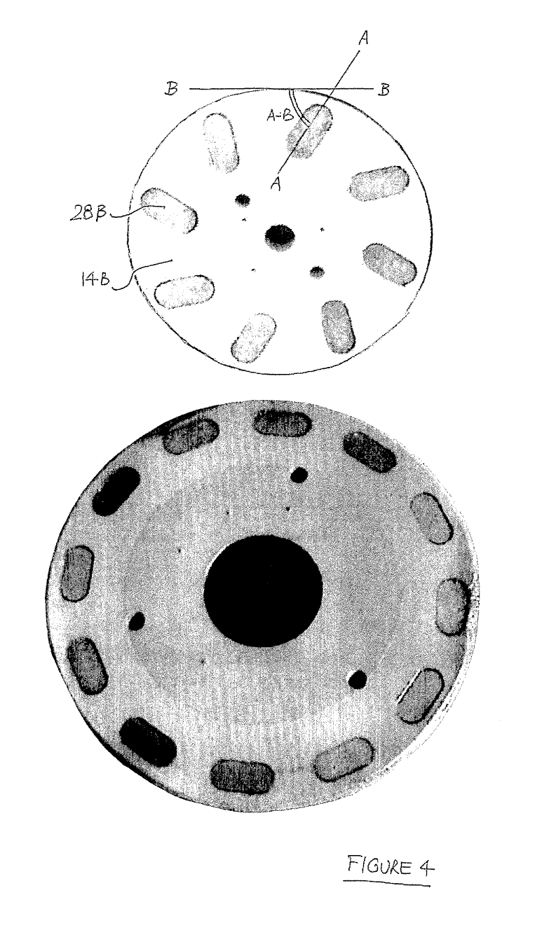

As shown in FIGS. 1 and 2, the magnets 22 on the primary 10 and those 28, 30 on the secondary discs 14, 16 are obround shaped (ie. pill-shaped). The obround-shaped magnets on each disc are oriented axially outward from the centrepoint 20, 21 of the respective discs 10, 14, 16. The shape of the outermost faces of the embedded magnets on the opposing faces on the primary and secondary discs is the same. Turning to FIGS. 3 and 4, the magnets 22A on the primary 10A and those 28A on secondary disc 14A shown are also obround in shape, however the magnets 28A on the secondary disc(s) are oriented with their respective axes (eg line A-A) arranged at an acute angle A-B to the periphery of the disc (eg line B-B), whereas the magnets 22A on the primary disc 10A are oriented radially axially outwardly from the centrepoint 20A of the disc 10A as was the case in FIG. 1. Turning to FIG. 5, on the primary disc 10C a plurality of obround shaped magnets 22C are aligned generally end to end (but spaced apart) on the primary disc 10C in a concentric ring configuration 32 that is located adjacent to the periphery of the disc 10C. These magnets 22C are each arranged with their elongate axis located at right angles to the radius of the disc 10C. The magnets on the secondary disc 14C are oriented radially axially outwardly from the centre point of the disc 14C as was the case in FIG. 1.

In further embodiments, any combination of magnets can be arranged with a respective elongate axis thereof that is: (a) radially aligned, (b) arranged at an acute angle to, or (c) orthogonal to the radius of the support disc, or any combination thereof.

The inventor believes that he has been able to achieve an increase in the torque between the primary and secondary discs by varying the arrangement and type of magnets located on those discs. Without wishing to be bound by theory, the inventor believes that by using magnets on the primary and secondary discs that are non-circular in shape, there is an increase in the torque interaction generated between the discs. A greater interaction between the rotating discs means that the power transferred therebetween may be increased. The inventor surmises that magnets which are elongate can transmit more power therebetween (compared with, say, round button magnets) because of the increase in the overlap of the more elongated magnetic fields on respective adjacent magnets.

When an elongate magnet (e.g. having a flat or straight side edge in some forms) interacts with another elongate magnet, the inventor has also noted that there is less slippage between the supports which hold the magnets. It has also been observed that there is a reduction in the occurrence of ‘cogging effects’—that is, less operational ‘rough spots’, which often can arise with conventional meshed gear systems during rotation of the components. Finally, the inventor has observed that the use of elongate magnets can assist in handling some misalignment which may occur between primary and secondary support discs during use, thus allowing smoother operation.

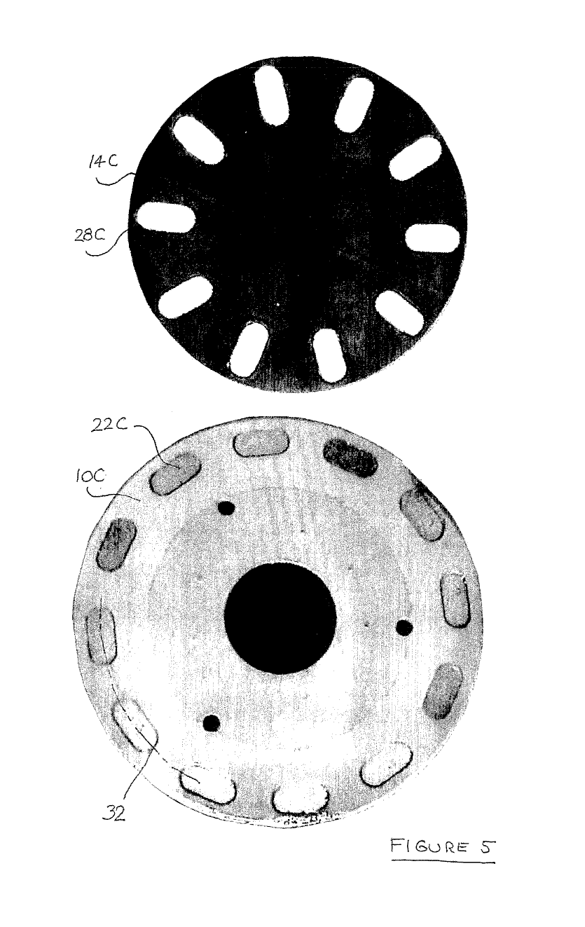

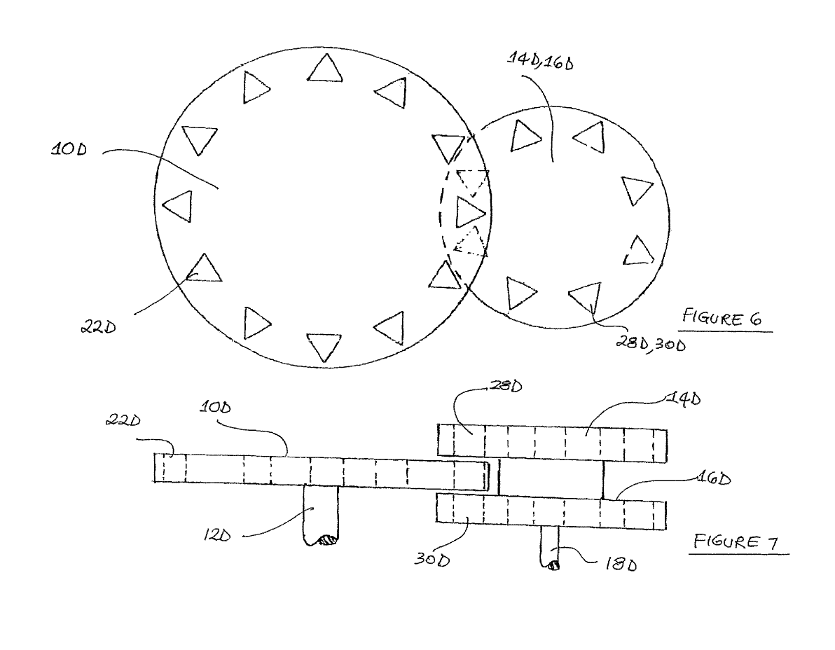

In the embodiment shown in FIGS. 6 and 7, in all other respects the apparatus shown is similar to that described in FIGS. 1 and 2, however the embedded magnets 22D, 28D, 30D are shaped as equilateral triangles. In the embodiment shown, the first 12D and second 18D shafts are both oriented in the same longitudinal plane but offset to each other and extend in the same direction. The first and second shafts are also of differing diameters. In the embodiment shown in FIGS. 8 and 9 the embedded magnets are of a rhomboid shape 22D, 28D, 30D. In still further embodiments, the embedded magnets can have a shape that is selected from one or more of square, rectangular, non-equilateral triangular, ovaloid, or truncated cylinder. Any combination of these magnet shapes can be used where appropriate.

In further embodiments, the orientation of the shape of the embedded magnets on the primary disc need not be aligned with the orientation of the embedded magnets on the secondary disc(s). Furthermore, the number of magnets embedded in the primary disc and secondary discs can vary according to the diameter of the respective discs (differing magnetic density). Also the respective quantity of magnets embedded in the primary disc need not be equivalent to the quantity of magnets embedded in the secondary discs.

In still further embodiments, it is possible for the primary and secondary supports for the magnets to be non-circular in shape, for example oval or even square shaped, as long as the partial alignment of the magnets between adjacent rotating supports can occur.

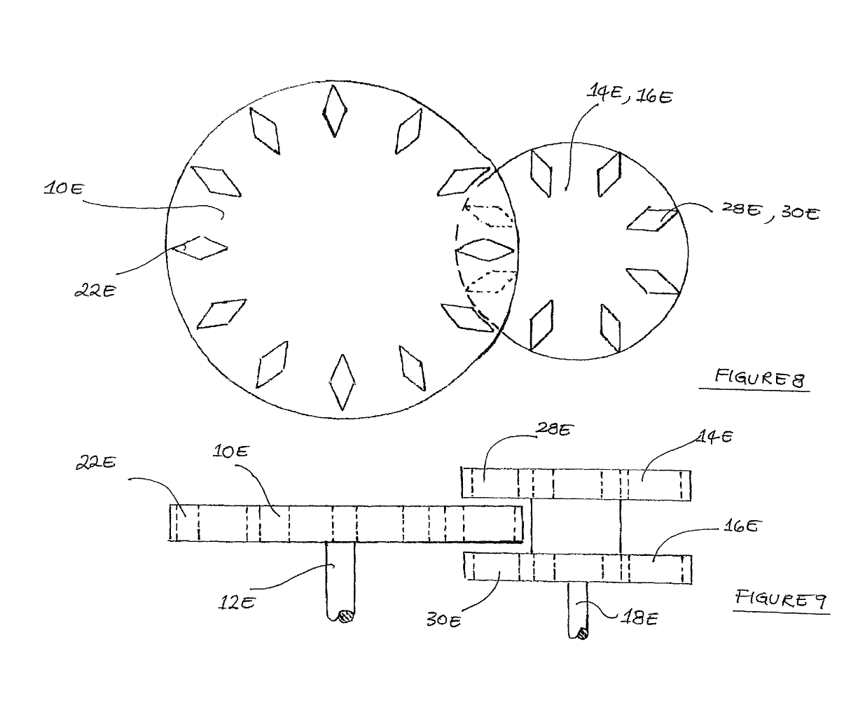

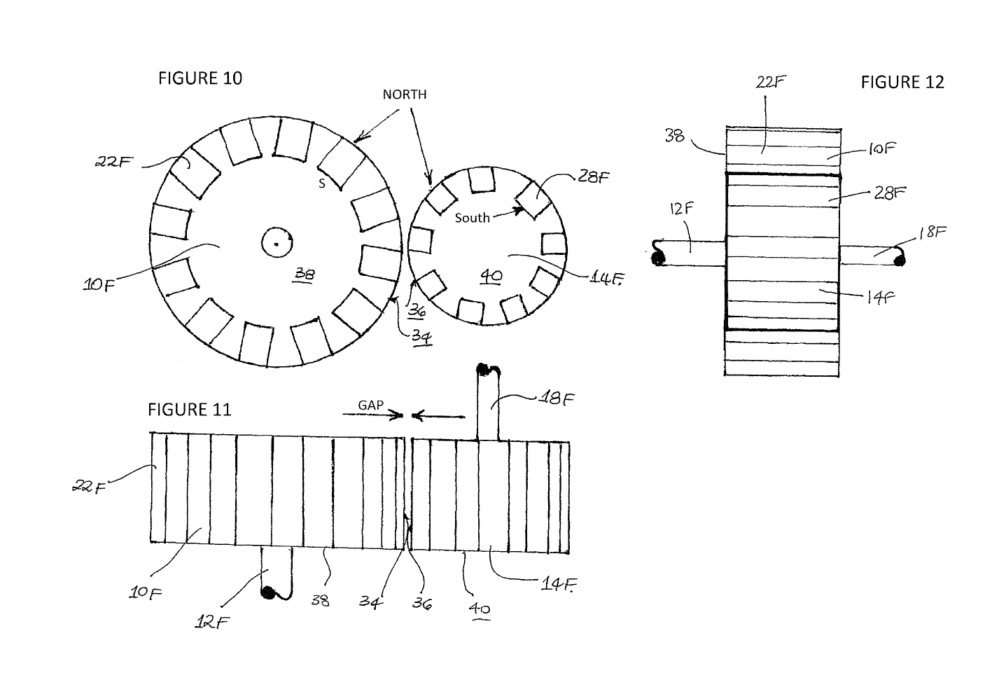

Referring now FIGS. 10 to 12, the present invention has a plurality of embedded magnets shaped as elongate, straight-sided, cylindrical segments of a generally rectangular cross-sectional shape, and a primary 10F and a secondary 14F disc that are oriented such that the outermost periphery 34 of the primary disc 10F is located in close proximity to the outermost periphery 36 of the secondary disc 14F. Twelve magnets 22F and nine magnets 28F are embedded into respective of the primary 10F and secondary 14F discs, such that each of the magnets 22F, 28F are flush with the outermost periphery 34, 36 of the disc(s) and with the opposing planar end faces 38, 40 of these discs. In the embodiment shown, the magnets 22F that are embedded in the primary disc 10F are each oriented such that the polarity of the outer face of each magnet (ie. the face located at the outermost periphery 34 of the primary disc 10F) matches the polarity of the outer face of a magnet 28F positioned at the periphery 36 adjacent secondary disc 14F. In the embodiment shown in FIG. 10, each of the magnets embedded in the primary disc 10F has a North pole which is aligned with a North pole of a magnet 28F embedded in the secondary disc 14F.

As shown in FIG. 11, the magnets 22F are shown aligned with the first shaft 12F, and the magnets 28F are shown aligned with the second shafts 18F. Ideally in use the magnets on the primary 10F and secondary 14F discs (respectively the magnets 22F and 28F) are arranged so as to be parallel, with their respective elongate, straight side edges aligned. In use, the inventor has observed that such an arrangement can result in less slippage between the discs 10F, 14F which hold the magnets 22F, 28F respectively, and can assist in handling some misalignment which may occur between primary 10F and secondary 14F discs during use, thus allowing smoother operation.

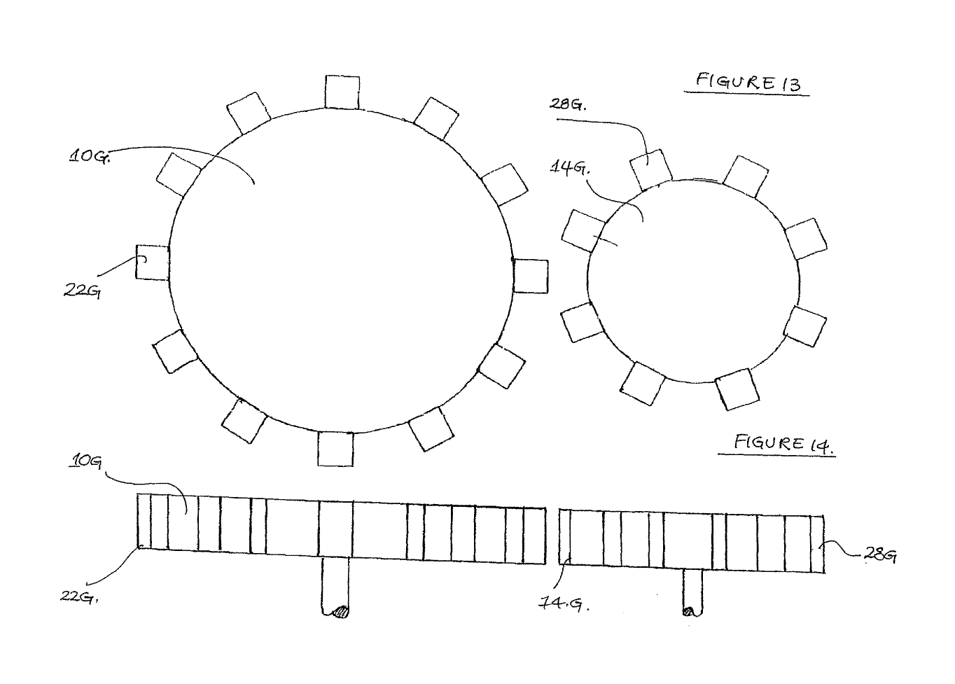

Turning now to the apparatus shown in FIGS. 13 to 14, which is similar in many respects to that shown in FIGS. 10-12, a plurality of elongate shaped magnets 22G, 28G with straight side edges are shown externally mounted to the respective radial periphery of each of a primary 10G and a secondary disc 14G to project therebeyond, rather than being recessed or inset into the disc(s) as shown in FIGS. 10-12. This arrangement has many of the same operational advantages as discussed hereinabove in relation to the apparatus shown in FIGS. 10-12.

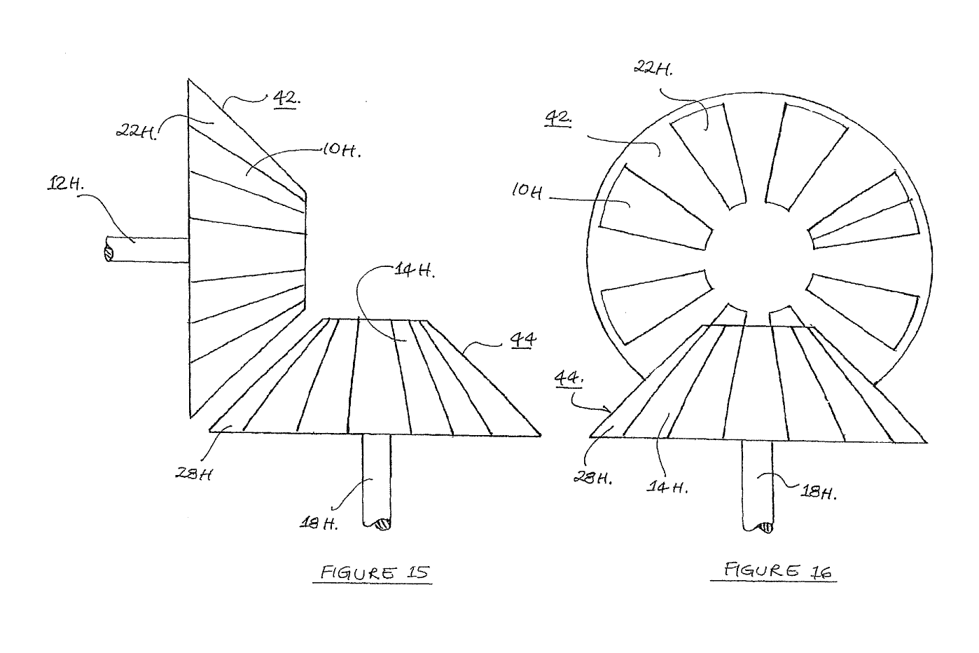

In a further embodiment shown in FIGS. 15 and 16, there is shown a magnetic drive apparatus which includes two rotatable shafts 12H, 1811 which are inclined orthogonally to one another, and each shaft has a respective terminal head 1011, 1411 which are each generally conical in shape. In the particular embodiment shown, the terminal heads 10H, 1411 are of a truncated cone shape. There are a plurality of magnets arranged around each terminal head 1011, 1411, located on the skirt-shaped major cone face 42, 44. In use, respective terminal heads 1011, 1411 are rotated so that adjacent skirt-shaped major cone faces 42, 44 are moved in close proximity with one another. Each skirt-shaped major cone face 42, 44 has a plurality of magnets in the form of elongate, truncated frustoconical segments 2211, 2811 arranged to extend from the notional apex towards the base of the generally conical head. These magnets are recessed into the skirt-shaped major cone face 42, 44 of each terminal head 1011, 18H so as to be flush therewith. In the embodiment shown, the magnets 2211, 28H that are embedded in the skirt-shaped major cone faces 42, 44 are each oriented such that the polarity of the outer face of each magnet (ie. the face located at the outermost periphery of the terminal head) matches the polarity of the face of a corresponding magnet positioned in the adjacent terminal head. Therefore because of the repulsive magnetic force between corresponding magnets on adjacent terminal heads, the rotation of a first shaft can result in the rotation of a second shaft, and vice versa.

In still further embodiments, other respective angles of inclination can be arranged between two rotatable shafts, other than orthogonal.

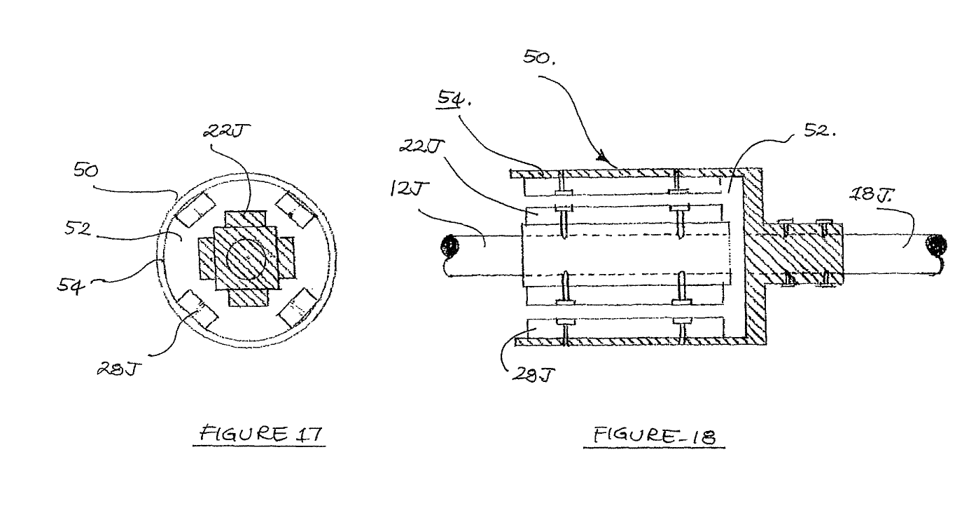

Turning now to the embodiment shown in FIGS. 17-18, a magnetic coupling is shown which magnetically couples a primary 12J and a secondary elongate shaft 18J. In the embodiment shown, each shaft 121, 18J has an elongate axis that is aligned with the other in use. Each shaft 12J, 181 is rotatable around its elongate axis.

In the embodiment shown in FIGS. 17 and 18, there are four elongate magnets 22J arranged around an end of the primary shaft 121. The end of the secondary shaft 18J is screw-fitted with a housing in the form a cylindrical casing 50 which encloses a cavity 52. The interior wall 54 of the casing 50 is also fitted four elongate magnets 281. When the end of the primary shaft 121 (and four magnets 221) are positioned within the cavity, with an annular space arranged between the end of the primary shaft 121 and the interior wall 54 of the casing 50, the repulsive forces between the magnets 22J of the primary shaft 121 and those magnets 28J of the casing 50 can cause the relative rotation of the primary and secondary shafts if one or the other shaft is first caused to rotate. The magnets 281 fitted to the interior wall 54 of the casing 50 are not embedded flush with the interior wall of the casing, but are mounted by screwing or other means so as to be seated proud of the interior wall 54.

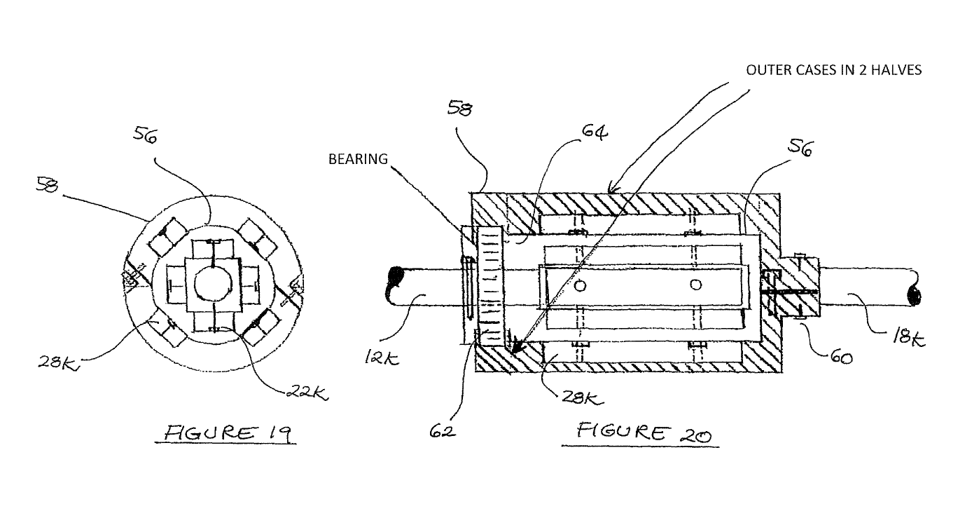

In the embodiment shown in FIGS. 19 and 20, the magnets 28K are embedded flush with the interior wall 56 of the casing 58. The casing 58 is arranged to be assembled from two half-cylinders and held together at the second shaft 18K by screws 60. Alternatively the casing can be formed as one piece, and in this or another form, can be attached by any means to the secondary shaft 18K. The magnets 28K embedded in the interior wall 56 of the casing 58 are oriented such that the polarity of the outer face of each magnet matches the polarity of the outer face of a respective magnet mounted on the primary shaft located within the cavity. A bearing 62 is located about the circumference of the primary shaft 12K and across the entrance of the cavity 64 to support a true alignment of the primary 12K and secondary 18K shafts in use, for example to restrict misalignment.

In further embodiments, there is no particular requirement for four magnets to be used, as illustrated, but any number of elongate magnets can be arranged about the peripheral end of the primary shaft and interior wall of the casing.

With regard to any of the forms of the invention disclosed herein, in still further embodiments the magnets used can also comprise an electromagnet or any other magnetisable material formed into non-circular shapes. When the term “elongate” is used in relation to magnets it is to be appreciated that a series of aligned magnets of a smaller length can be arranged to produce an elongated magnetic strip, for example, which functions as well as a single elongate magnet.

Also, when the term “elongate” is used herein in relation to magnets, it is to be understood that, in some forms, the opposing sides of the magnet can be parallel, and in some other forms these opposing sides can be straight-edged. However, the term “elongate” is not so limited, and can include magnets in forms with non-straight and non-parallel sides that are simply of a shape longer than they are wide.

Whilst the invention has been described with reference to a specific embodiment, it should be appreciated that the invention can be embodied in many other forms.

It is to be understood that, if any prior art information is referred to herein, such reference does not constitute an admission that the information forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

1. A magnetic drive apparatus comprising:
a primary and two secondary supports, each support being rotatable around an axis of rotation; and
a plurality of magnets arranged around and at or adjacent to a periphery of each support;
wherein the secondary supports are spaced and generally parallel, and the primary support is arranged in use to move in the space between the secondary supports such that, at a given time, at least some of the primary magnets are located between at least some of the secondary magnets of each of the secondary supports.

2. A magnetic drive apparatus in accordance with claim 1 wherein the magnets of the primary and secondary supports are each oriented so that the poles of said at least some primary magnets provide a repulsive magnetic force to said at least some secondary magnets.

3. A magnetic drive apparatus in accordance with claim 1 wherein the primary support is a disc that is mounted to rotate on the end of a primary shaft and the secondary supports are each discs mounted to rotate on a common secondary shaft.

4. A magnetic drive apparatus in accordance with claim 3 wherein the primary shaft is parallel in use to the secondary shaft.

5. A magnetic drive apparatus in accordance with claim 3 wherein the secondary discs each have the same diameter that is a smaller diameter than the primary disc.

6. A magnetic drive apparatus in accordance with claim 1 wherein the magnets on at least one support can be energised by at least one electromagnet to induce rotation between the primary and secondary supports.

7. A magnetic drive apparatus in accordance with claim 1 wherein each of the magnets is shaped to improve torque generation.

8. A magnetic drive apparatus in accordance with claim 7 wherein each magnet has an ovaloid or an obround shape.

9. A magnetic drive apparatus in accordance with claim 1 wherein each of the magnets is elongate and has an elongate axis that is inclined to a radius extending from a centre of each support.

10. A magnetic drive apparatus in accordance with claim 9 wherein the elongate axis subtends an acute or right angle to the radius, or the magnets on each support have varying combinations of these orientations.

11. A magnetic drive apparatus in accordance with claim 1 wherein each of the magnets has a shape that is selected from one or more of square, triangular, ovaloid, obround, rhomboid, or truncated cylinder.

12. A magnetic drive apparatus in accordance with claim 1 wherein the magnets in each support are mounted to project beyond the outer periphery thereof, or are mounted to recess into the outer periphery.

13. A magnetic drive apparatus comprising:
primary and secondary supports, each support being rotatable around an axis of rotation that is parallel or inclined with respect to the other axis; and
a plurality of magnets arranged around each support;
wherein each support has a generally conical shape, with a major cone face of one support facing a major cone face of the other support in use.

14. A magnetic drive apparatus in accordance with claim 13 wherein each magnet is elongate and is arranged in major cone face to extend from an apex towards a base of the cone.

15. A magnetic drive apparatus in accordance with claim 14 wherein each magnet has the form of a frusto-conical segment.

16. A magnetic drive apparatus in accordance with claim 13 wherein the magnets in one support are oriented to provide a repulsive magnetic force to the magnets in the other support.

17. A magnetic drive apparatus in accordance with claim 13 wherein the supports are each mounted to rotate on the end a respective shaft.

18. A magnetic drive apparatus in accordance with claim 17 wherein the axis of one shaft is in use orthogonal to the axis of the other shaft.

19. A magnetic drive apparatus in accordance with claim 13 wherein each support is frusto-conically shaped.

20. A magnetic drive apparatus comprising:
a primary and a secondary support, each support being rotatable around an axis of rotation; and
a plurality of magnets arranged around and at or adjacent to a periphery of each support;
wherein the magnets are elongate and are generally arranged in alignment with the axis of rotation of the respective support.

21. A magnetic drive apparatus in accordance with claim 20 wherein the primary and secondary supports are spaced apart.

22. A magnetic drive apparatus in accordance with claim 20 wherein the primary support is a disc that is mounted to rotate on a primary shaft and the secondary support is also a disc mounted to rotate on a secondary shaft.

23. A magnetic drive apparatus in accordance with claim 22 wherein the primary shaft is parallel in use to the secondary shaft.

24. A magnetic drive apparatus in accordance with claim 22 wherein the magnets on the primary support are arranged parallel with the magnets on the secondary support in use.

25. A magnetic drive apparatus in accordance with claim 22 wherein the secondary disc has a diameter that is a smaller than the diameter of the primary disc.

26. A magnetic drive apparatus in accordance with claim 20 wherein each magnet has a rectangular shape when viewed in plan or in cross-section.

27. A magnetic drive apparatus in accordance with claim 20 wherein the magnets in each support are mounted to project beyond the outer periphery thereof, or are mounted to recess into the outer periphery.

28. A magnetic drive apparatus comprising:
a primary and a secondary support, each support being rotatable around an axis of rotation; and
a plurality of magnets arranged around and at or adjacent to a periphery of each support;
wherein the magnets are elongate and are generally arranged transverse to the axis of rotation of the respective support.

29. A magnetic drive apparatus in accordance with claim 28 wherein each of the magnets has an axis that is inclined to a radius extending from a centre of each support.

30. A magnetic drive apparatus in accordance with claim 28 wherein the elongate axis subtends an acute or right angle to the radius, or the magnets on each support have varying combinations of these orientations.

31. A magnetic drive apparatus in accordance with claim 28 wherein each of the magnets has an axis that is aligned with a radius extending from a centre of each support.

32. A magnetic coupling apparatus comprising:
primary and secondary elongate shafts, each shaft having an elongate axis that is aligned with the other in use, and each being rotatable around its elongate axis;
one or more primary magnets arranged around a first end of the primary shaft; and
one or more secondary magnets arranged at an end of the secondary shaft that is located adjacent to the primary shaft first end in use, the secondary magnets being arranged such that the primary magnets are located in use to rotate within the secondary magnets.

33. A magnetic coupling apparatus in accordance with claim 32 wherein the primary and secondary magnets are each oriented so that the poles of the primary magnets provide a repulsive magnetic force to the secondary magnets.

34. A magnetic coupling apparatus in accordance with claim 32 wherein a plurality of primary magnets surround the primary shaft first end.

35. A magnetic coupling apparatus in accordance with claim 32 wherein the secondary magnets are arranged, within a housing that is mounted to the secondary shaft end to rotate therewith, with the primary shaft first end being located within the housing in use.

36. A magnetic coupling apparatus in accordance with claim 35 wherein the housing is a casing assembled form two halves and then mounted to the secondary shaft end to define the housing.

37. A magnetic coupling apparatus in accordance with claim 32 wherein the housing has a bearing located at an entrance thereto through which the primary shaft extends to be supported for rotation therein in use.

38. A magnetic coupling apparatus in accordance with claim 32 wherein the primary and/or secondary magnets are elongate.
